(19) United States
(12) Patent Application Publication
(10) Pub. No.: US 2016/0300422 A1
(43) Pub. Date: Oct. 13, 2016

(54) Double Thick Vending Machine Stack Wall

(71) Applicant: Automated Mechandising Systems Inc., Kearneysville, WV (US)

(72) Inventor: Paul Mason, Inwood, WV (US)

(21) Appl. No.: 14/684,904

(22) Filed: Apr. 13, 2015

(51) Int. Cl. G07F 9/10

(52) U.S. Cl. CPC G07F 9/10

(57) ABSTRACT

An internal stacking wall structure for use in forming a product holding area of a vending machine for vending selected products contained therein. Vending machines include an open interior closed by a separate front door with an internal product holding assembly in which product to be dispensed can be held in a plurality of product holding compartments formed by spaced apart stacking walls. The stacking walls are comprised of a pair of facing substantially flat panels each having a plurality of inwardly facing, spaced apart, recesses formed therein, or spacers between the panels, or other panel separators, and a plurality of fasteners operatively connecting the pair of facing panels together forming a double wall structure with the inwardly facing recesses on each panel facing the opposing panel, or with spacers or separators positioned within the interior of the stacking wall structure.

### CROSS-REFERENCE TO CO-PENDING APPLICATIONS

The present invention is related to the following co-pending U.S. patent application which is all commonly owned with the present application, the entire contents thereof being hereby incorporated herein by reference thereto: U.S. patent application Ser. No. ______, entitled “______,” filed on ______.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This disclosure relates to structures used in vending machines as stack walls to separate one set of products from another set of product inside the product holding area of a vending machine.

### INTRODUCTION

This invention relates to vending machines, and in particular, to vending machines that can be stocked with vertical stacks of vendable products and with vertical stacks of products retained in columns in a product storage area therein.

Vertical stacks are one way to store and dispense products in vending machines and for many products is an efficient and effective way to store a maximum number of products. This is important as the more items that can be stored in the machine the less often is the need to restock.

In a vending machine, internal column walls are employed to define product storage magazines or zones. More specifically, a series of column walls are arranged at spaced positions within a vending cabinet and serve as partitions to contain, separate, and support a stack of products to be dispensed. In prior art vending machines the overall series of column walls are often interconnected to maintain their desired spaced relationships. This can be accomplished by a plurality of cross braces, vertically spaced front and rear braces, or cross braces across various portions of the walls. Further, regardless of the existence of any bracing which might be used effectively to capture the front, rear, and top portions of the column walls, the center sections of the column walls still need to be stiffened in order to prevent bowing due to the weight of the contained products, and bowing can hamper proper product dispensing.

Prior art stacked product containment walls were primarily formed from sheet metal. To strengthen the sheet metal wall the outer edges might be bent or shaped to provide added perimeter strength, and the central portions might be stiffened by various bracing components which could extend fore-to-aft or diagonally along the wall and be mechanically fastened to these.

### DESCRIPTION OF PRESENTLY PREFERRED EXAMPLES OF THE INVENTION

### Brief Description of Figures

The invention is better understood by reading the following detailed description with reference to the accompanying drawings in which:

FIG. 1 is a frontal perspective showing the outside of a vending machine;

FIG. 2 is a side view of the inside of a vending machine;

FIG. 3 is a frontal perspective showing the inside of a vending machine and the product holding area with the stacking walls and product compartments;

FIG. 4 is a perspective view of the sheets comprising a stack wall;

FIGS. 5A and 5B shows two different forms of mating edges of adjacent wall panels;

FIG. 6 is an additional embodiment of the present invention; and

FIG. 7 is a further embodiment of the present invention.

### DESCRIPTION

### A. Overview

To gain a better understanding of the invention, a preferred embodiment will now be described in detail. Frequent reference will be made to the drawings. Reference numerals or letters will be used throughout to indicate certain parts or locations in the drawings. The same reference numerals or letters will be used to indicate the same parts and locations throughout the drawings, unless otherwise indicated.

### B. Environment

The preferred embodiment now described will be with respect to a vending machine and to separate various sets or groupings of products from each other within the interior of a vending machine. The scale of the embodiment, therefore, is to be understood with respect to this type of article. It is to be understood as well, however, that the invention is applicable to other articles and its scale can vary accordingly.

### C. Structure

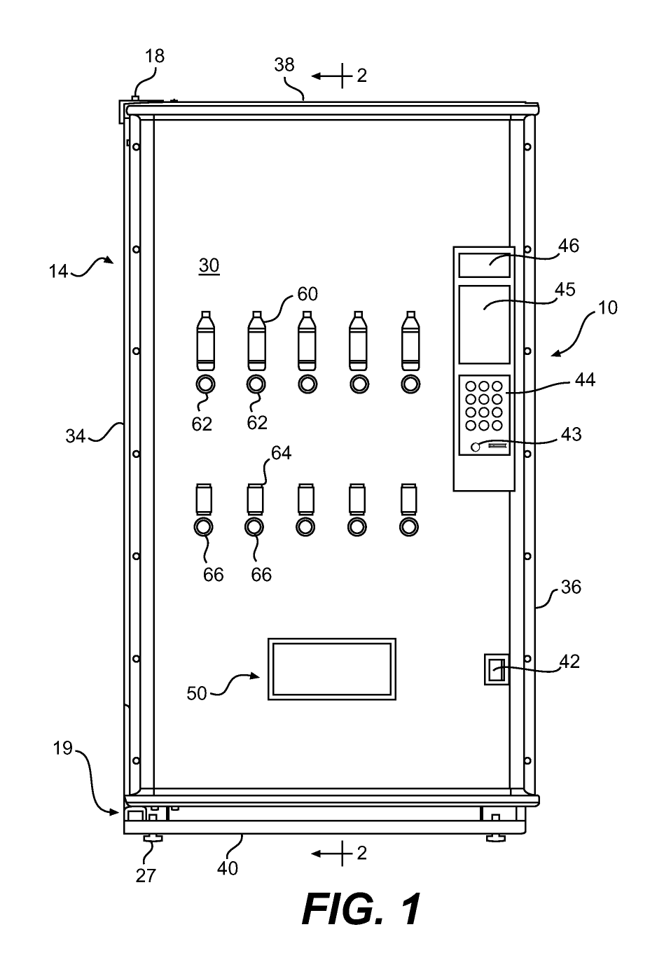

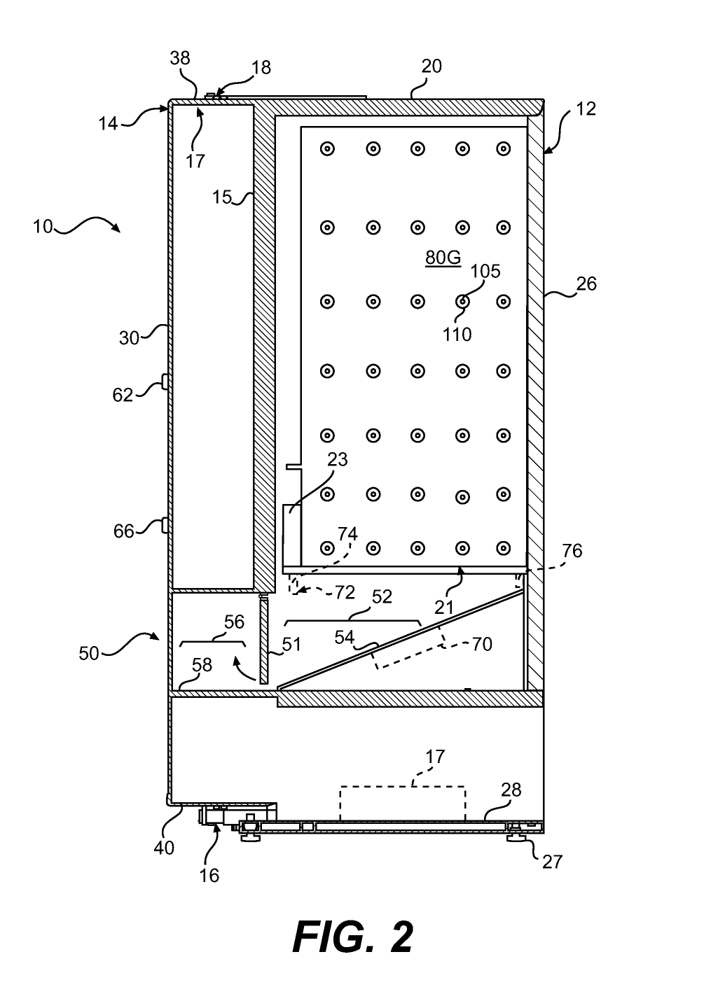

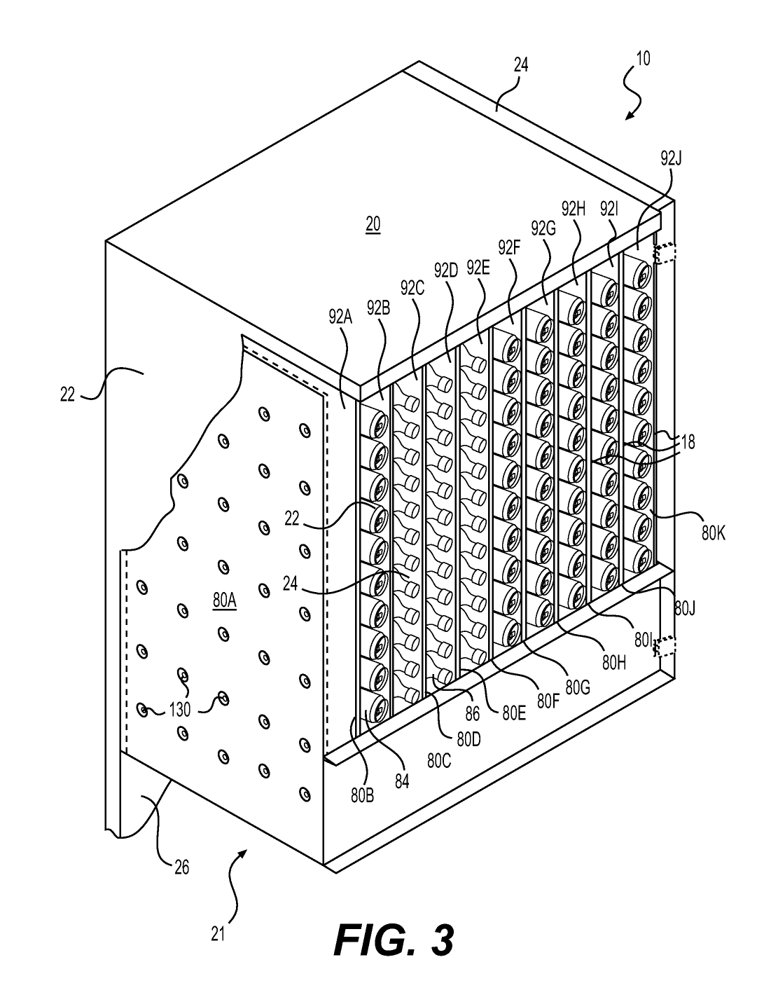

FIGS. 1 and 2 show such a closed front vending machine 10 as being comprised of a case or cabinet 12 that includes a front door 14 and a rear cabinet 16. Front door 14 is pivotally mounted to the rear cabinet by top and bottom hinges 18 and 19, respectively. Front door 14 includes an inner door 15 that can be pivotally attached either to an inside portion of an outer portion 17 of the front door, or to the rear cabinet 12, and in either case by hinges (not shown). The outer portion 17 is designed to overly the inner door 15 with the latter being an insulating door that will close over the front of the product holding section 21, as shown in FIG. 3, to keep the contents of a product holding section 21 cold when vending cold or frozen products. The vending equipment 10 can also include a suitable refrigeration unit 17, as shown in FIG. 2, to maintain desired temperatures within the product holding section 21.

With reference to FIGS. 2 and 3 the main rear cabinet is 16 that is itself comprised of separate top wall 20, opposing side walls 22 and 24, a rear wall 26 and a bottom wall 28, as well as a plurality of height adjustable feet 27. The front door 14 and the rear portion 16 collectively define the outer casing structure 12 for the vending machine 10.

The front door 14 includes a front panel 30 that is retained in a frame formed from opposing sides 34 and 36, a top 38 and a bottom 40. Door 14 also includes and supports a coin changer including a change return 42, a suitable keypad 43, a control panel 44, a display 45, and a retrieval door mechanism 50. Door 14 has sufficient internal space to mount other parts of the vending machine such as, for example, control electronics, the coin changer assembly, a bill validator 46, or other devices as may be desired. The front panel 30 can also include exemplary bottles 60 and bottle selection buttons 62 and exemplary cans 64 and can selection buttons 66.

The vending machine 10 includes a product holding section 21, as shown in FIG. 3, that can be comprised of a plurality of spaced apart product containment walls 92A-92J, as will be discussed hereinafter, forming between a pair of such adjacent walls product holding compartments in which product, such as, for example, cans or bottles, can be stacked vertically. The product holding section 21 can also include any form or grouping of known product dispensing assemblies 23 there below each area of stacked product as one might envision for such a vending machine 10, which can be of varying types and/or configurations, limited only by the particular products one might choose to vend from within the vending machine as a whole. The vending machine 10 will also include suitable vend motors, not shown, as part of the product dispensing assemblies as needed to dispense product from each of the plurality of columns or product holding compartments containing stacked products within the product holding section 21.

Located below the product holding section 21 is a drop zone area 52 at the bottom of which is a product directing ramp or panel 54 that is an angled sheet, for example of metal or plastic, whose angle of inclination from back to front will direct a dispensed product falling from the product holding section 21 forwardly through a swinging door 51 and toward a front product retrieval area 56 and onto floor 58 thereof from which the selected and dispensed product can be retrieved via the opening 50.

The vending machine 10 can also include a suitable vend detection or sensing system. One such system is shown in phantom at 70 is a vibration sensor attached to the bottom side of ramp or plate 54 to sense when a product has fallen onto that ramp or plate 54. A vend sensing system could also be of an infrared type as is diagrammatically shown generally at 72 in FIG. 2 and includes suitable emitter/detector units, 74/76, respectively, extending along each of the two opposing sides or ends of the space or drop zone 52, which will create a plane of infrared radiation operating across the depth and width of the drop zone 52 so that along with suitable control equipment the system will sense passage of a dispensed product falling through the field of radiation.

FIG. 3 shows a cut away view of the interior of a vending machine 10 and the product holding section 21 that is comprised of a plurality of internal stacking walls 80A-80K, as shown from left to right, that are spaced apart to form a plurality of product holding compartments 92A-92J in which product is stacked, for example in rows, prior to being vended. Compartment 92B is shown as holding stacked rows of cans 84 while compartment 92C is holding stacked rows of bottles 86.

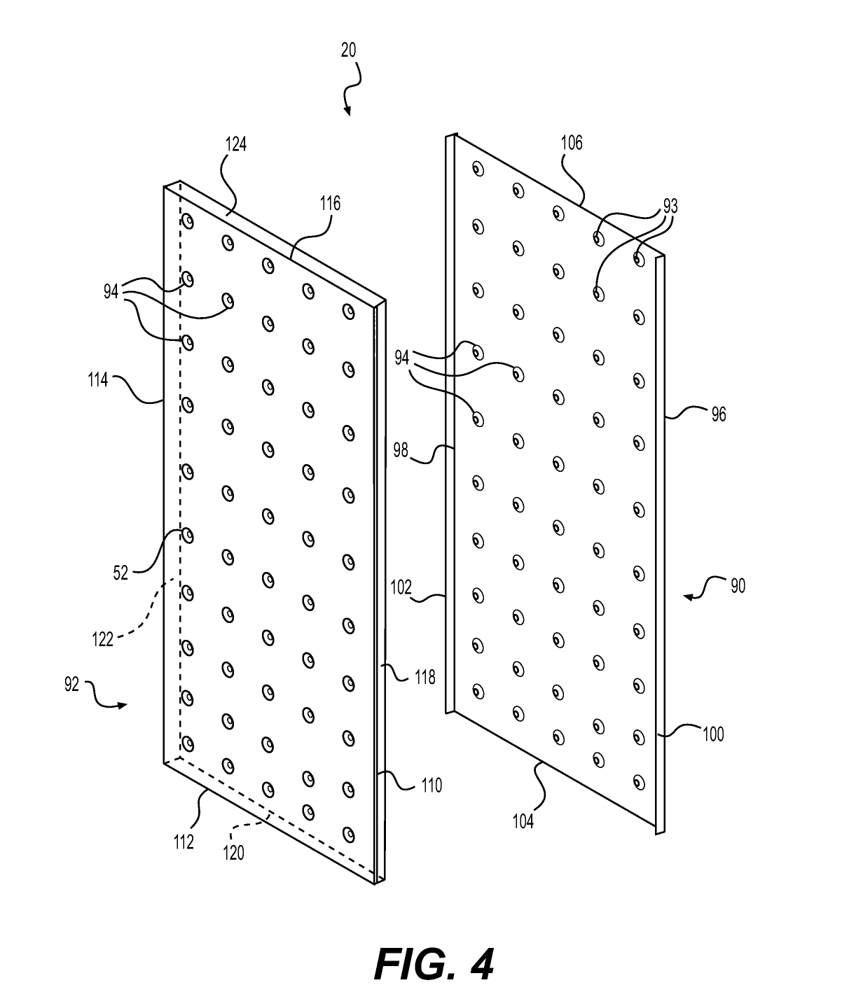

Each of the stacking walls 80A-80k, as shown in FIG. 4, is comprised of two panels and in particular right and left panels, 90 and 92, respectively. Each panel 90/92 is preferably formed from sheet metal, but they could also be cast, molded or otherwise formed. Each panel 90/92 can be provided with a plurality of inwardly directed dimples 94 that are positioned so that when the panels 90/92 are connected and secured together, for example by rivets 130 shown in FIG. 3, the inside surfaces 93 of each of the dimples 94, as shown in FIG. 4, on one panel 90 will contact and mate against the corresponding inside surface of the opposing recesses or dimples on the opposing panel 92. The dimples or recesses 94 are preferably stamped into each panel by passing each panel 90/92 through a sheet forming press or apparatus in which suitable dies will create rows of the dimples or recesses 94. Such sheet forming apparatus can feed panels either sequentially, so that row after row can be formed, or fed so that more than one row could be formed during each stamping cycle, for example all pairs of rows or for that matter all of the rows on a single panel depending upon the precise apparatus being used. Since such stamping will employ known techniques no further explanation is believed to be warranted.

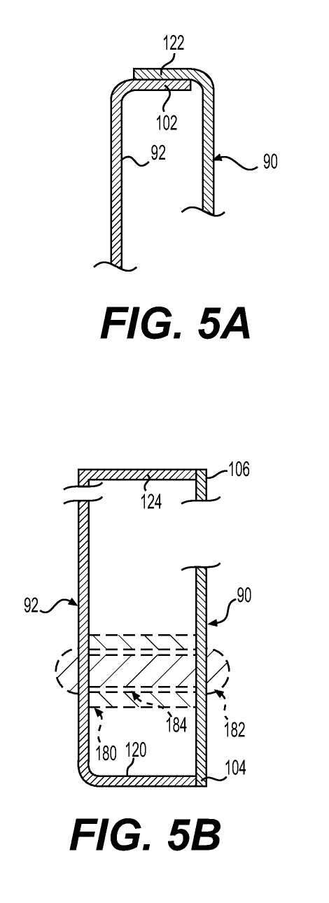

The panels 90/92 preferably have at least some of their outer edges formed into a right angle flange to thereby form an outer edge of the walls 80A/80K. For example front edge 96 and rear edge 98 on panel 90 can be formed with a right angle flange 100 and 102, while the bottom edge 104 and the top edge 106 would not have any flange thereon. However, for panel 92 all four edges 110, 112, 114 and 116 will preferably have a right angle flange formed therewith as shown at 118, 120, 122 and 124. When connected together the front flanges 100 and 118 will overlap as will the back or rear flanges 102 and 122, respectively, for example as is shown in FIG. 5A for flanges 102 and 122, while flanges 124 and 120 of panel 92 will meet the top and bottom edges 106 and 104 of panel 90 as is shown in FIG. 5B.

It should be understood that a variety of edge forming arrangements can be employed such as two short flanges that meet along a flange edge or curved or rounded flanges might be used that could then inter fit, or the flanges might be formed with a plurality of spaced apart flanges or flange segments, while the mating panel would have a similar structure but with its spaced apart flanges or segments formed so that its sets of flanges could interfit with or into the adjacent gaps or spaces in the first panel. It should also be understood that mating edges could be welded, spot welded, glued or to the extent there is a seam between the panels that seam could smoothed or rounded over to provide a clean and safe edge. Alternatively the mating edges could be left alone that would still form an outer edge of the stacking walls 80A-80K when the panels, for example 90 and 92, are mated together.

As noted above, panels 90/92 are preferably secured together by using rivets 130 that are placed in the center of the dimples or recesses 94. Alternatively, the mating dimple faces 93 could also be spot welded or otherwise secured so as to rigidly connect the two panels 90/92 together. The combined height or depth of each dimple 94 forming a distance between panels 90/92 that is preferably about 0.344 inches, although other thickness dimensions could vary from about 0.050 inches to about 0.750 inches. Each panel 90/92 can be preferably formed from 0.028 inch thick sheet metal, but the sheet metal could be as thin as 0.015 inches, and they could be formed from thicker material than the preferred 0.028 inch thickness, for example 0.100 inches.

By forming the stacking walls 80A/80K in this manner they have sufficient strength to fully support products stacked in the compartments 82A-82J as shown in FIG. 3 without any further bracing and without bowing under the forces from products stacked within a particular compartment 92A-92J. Stacking walls 80A-80K preferably can be about 21 inches wide and about 46 inches high, but the precise size will depend upon the particular vending machine and product holding area. However, it is believed that the above preferred size will fit within most standard sized vending machines. Where a vending machine is larger or smaller than an industry standard size the internal stacking walls 80A-80K can be appropriately sized for that particular vending machine size.

### E. Options and Alternatives

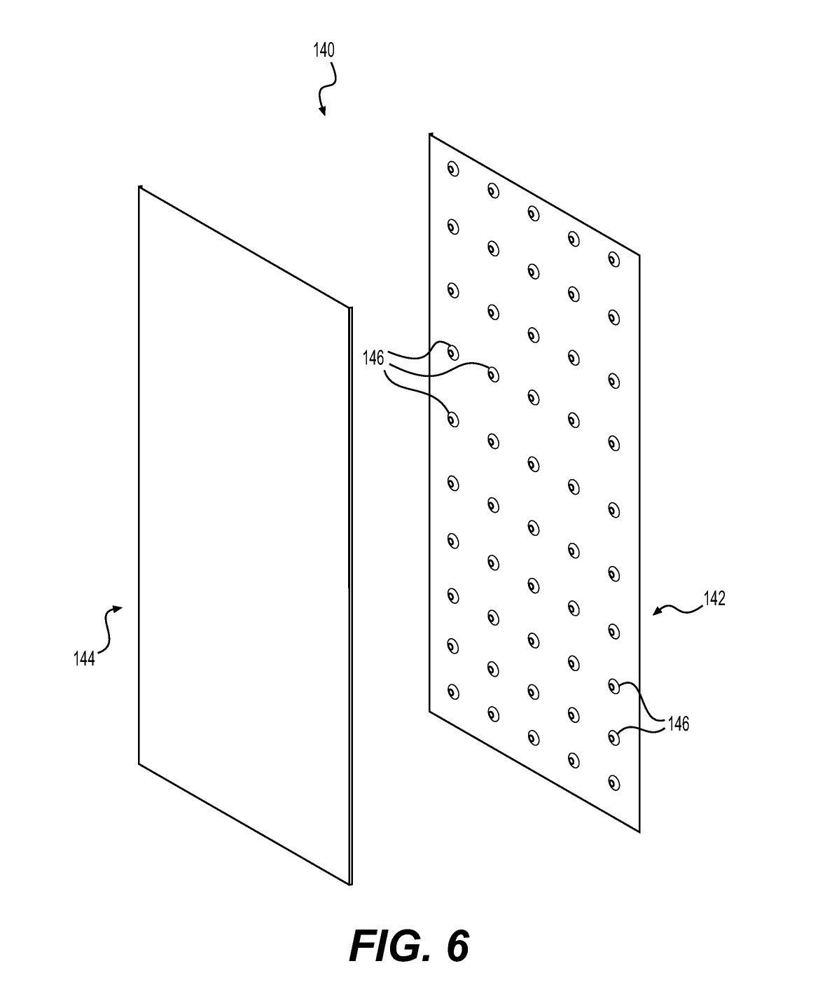

The present invention also includes various other panel configurations. For example, FIG. 6 shows a stacking wall 140 as being comprised of panels 142 and 144, but here only panel 142 includes a plurality of dimples or recesses 146, that can again be formed by known stamping techniques and processes, while the opposing panel 144 has no dimples. Consequently, the height or depth of dimples or recesses 146 will themselves define the interior spacing between panels 142/144 in a completed wall 140. The two panels 142/144 can be secured together to form stacking wall 140 by spot welding the inside of dimples 146 to sheet 144, rivets could be used, or other known securing techniques could also be employed so long as a secure connection resulted. The desired completed wall thickness could be controlled by the height or depth of dimples 146. In addition, where rivets are to be used while the rivet head on the dimple side 142 will lie within the dimple, the rivet on the flat side or the exterior of panel 144 can be flattened or ground smooth so as to not interfere with the movement of product held against that side of the wall 140. Alternatively, one could install a pop rivet from the flat side so that the thin head would lie against the flat surface and not interfere with the product while the distorted side of the rivet would lie within the recess.

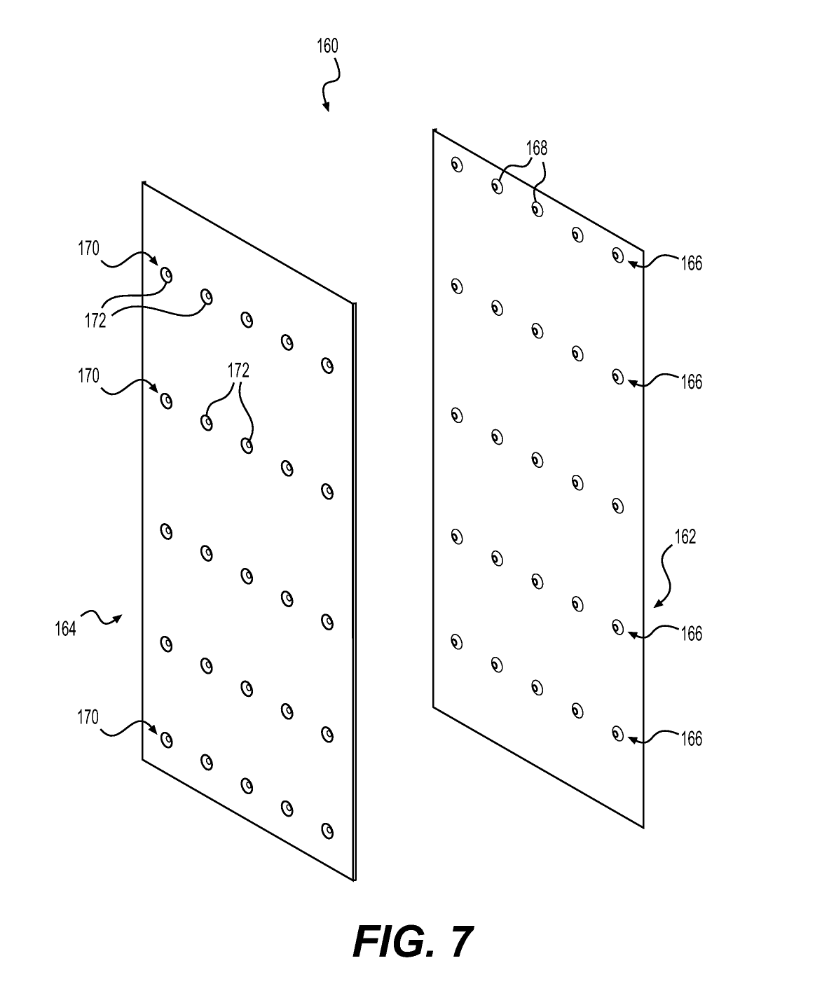

FIG. 7 shows another embodiment of a stacking wall 160 that is formed from two panels 162 and 164, where one panel 162 includes spaced apart rows 166 of stamped dimples 168 while the opposing panel 164 also has spaced apart rows 170 of stamped dimples 172, but with the location of the rows 170 being arranged to touch panel 162 in between the rows 166. As with the arrangement shown in FIG. 4 the panels 162/164 are preferably secured together, for example, by rivets, by spot welds or other known techniques.

As another alternative, instead of using stamped dimples, separate internal spacers could be used as shown in phantom at 180 in FIG. 5B to provide the desired internal space or gap between the two panels forming a wall. Rivets 182 would pass through each panel and through an internal core 184 of each spacer 180, with spacers being spaced apart across the length and width of the two adjacent panels to space the connected panels apart by a desired distance. Spacers 180 could be formed from metal, for example from tubing, or from plastic materials, polycarbonate or from other suitable materials that will provide the desired internal gap between the panels and effectively form the panels into a rigid structure.

While the panels are preferably formed from sheet metal, they can also be made from a variety of materials including plastics, polycarbonate, reinforced plastics, or they could be formed as a solid structure in which internal voids could be formed as desired.

When introducing elements of various aspects of the present invention or embodiments thereof, the articles “a,” “an,” “the” and “said” are intended to mean that there are one or more of the elements, unless stated otherwise. The terms “comprising,” “including” and “having,” and their derivatives, are intended to be open-ended terms that specify the presence of the stated features, elements, components, groups, and/or steps, but do not exclude the presence of other unstated features, elements, components, groups, and/or steps and mean that there may be additional features, elements, components, groups, and/or steps other than those listed. Moreover, the use of “top” and “bottom,” “front” and “rear,” “above,” and “below” and variations thereof and other terms of orientation are made for convenience, but does not require any particular orientation of the components. The terms of degree such as “substantially,” “about” and “approximate,” and any derivatives, as used herein mean a reasonable amount of deviation of the modified term such that the end result is not significantly changed. For example, these terms can be construed as including a deviation of at least +/−5% of the modified term if this deviation would not negate the meaning of the word it modifies.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An internal stacking wall structure for use in a product holding area of a vending machine to form a plurality of product holding compartments therein comprising a pair of substantially flat panels having top, bottom and side edges and each having a plurality of inwardly facing, spaced apart, recesses formed therein, and a plurality of fasteners operatively connecting the pair of facing panels together forming a double wall structure with the inwardly facing recesses on each panel facing the opposing panel.

2. The internal stacking wall structure as in claim 1 wherein the fasteners comprise rivets.

3. The internal stacking wall structure as in claim 1 wherein the fasteners comprise spot-welds at the juncture of inwardly facing and mating surfaces of the recesses.

4. The internal stacking wall structure as in claim 1 further including at least two outer edges of each panel that include an outwardly extending right angle flange.

5. The internal stacking wall structure as in claim 1 further including one panel having each of four outer edges that include an outwardly extending right angle flange and the other panel having at least two outer edges that include an outwardly extending right angle flange.

6. The internal stacking wall structure as in claim 1 wherein the recesses are located at spaced apart positions on facing sides of each of the pair of panels.

7. The internal stacking wall structure as in claim 1 wherein the recesses are located at spaced apart positions on only one of the pair of panels.

8. The internal stacking wall structure as in claim 1 wherein the recesses are located at alternating, spaced apart positions on each of facing sides of each of the pair of panels so that each recess will come into contact with an inside surface of the opposing panel.

9. A vending machine for vending selected products comprising a main body having top, bottom and side walls that define an open interior closed by a separate pivotally attached, open and closable, front door, an internal product holding assembly in which product to be dispensed can be held prior to being selected and dispensed to a retrieval assembly, the product holding assembly including a plurality of stacking walls spaced apart within the main body interior to thereby form a plurality of product holding compartments, each stacking wall comprising a pair of substantially flat panels having top, bottom and side edges and each having a plurality of separators positioned there between at spaced apart locations, and a plurality of fasteners operatively connecting the pair of panels together at the locations of the separators thereby forming a double wall structure.

10. The vending machine as in claim 9 wherein the plurality of separators comprise inwardly facing, spaced apart, recesses in which the recesses on each panel face the opposing panel of the stacking wall.

11. The internal stacking wall structure as in claim 10 wherein the fasteners comprise spot-welds at the juncture of inwardly facing and mating surfaces of the recesses.

12. The vending machine as in claim 9 wherein the separators comprise recesses formed on and at spaced apart locations on one of the pair of facing panels.

13. The internal stacking wall structure as in claim 12 wherein the fasteners comprise rivets positioned within the recesses.

14. The internal stacking wall structure as in claim 12 wherein the fasteners comprise spot-welds at the juncture of inwardly facing and mating surfaces on the other of the pair of facing panels.

15. The vending machine as in claim 9 wherein the separators comprise recesses formed on and at spaced apart and alternating locations on each of the pair of facing panels.

16. The internal stacking wall structure as in claim 9 further including at least two outer edges of each panel that include an outwardly extending right angle flange.

17. The internal stacking wall structure as in claim 9 further including one panel having each of four outer edges that include an outwardly extending right angle flange and the other panel having at least two outer edges that include an outwardly extending right angle flange.
